(19) United States
(12) Patent Application Publication
(10) Pub. No.: US 2021/0042661 A1
(43) Pub. Date: Feb. 11, 2021

(54) WORKLOAD MODELING FOR CLOUD SYSTEMS

(71) Applicants: Cedric ST-ONGE, Montreal (CA); Nadjia KARA, Kirkland (CA)

(72) Inventors: Cedric ST-ONGE, Montreal (CA); Nadjia KARA, Kirkland (CA)

(73) Assignee: TELEFONAKTIEBOLAGET LM ERICSSON (PUBL), Stockholm (SE)

(21) Appl. No.: 16/966,195

(22) PCT Filed: Feb. 20, 2019
(86) PCT No.: PCT/IB2019/051390

§ 371 Date: Jul. 30, 2020

Related U.S. Application Data
(60) Provisional application No. 62/633,376, filed on Feb. 21, 2018.

(51) Int. Cl. G06N 20/00; G06N 3/12

(52) U.S. Cl. CPC G06N 20/00; G06N 3/126

(57) ABSTRACT

There is provided a method an apparatus and an application instance, for estimating workload. The method comprises generating a workload model from observed workload data; generating at least two intermediate workload predictions using the workload model; and applying a genetic algorithm (GA) to the at least two intermediate workload predictions to generate a final workload prediction. The workload model may be generated by applying Hull-White modelling to a workload dataset derived from the observed workload data. Applying the GA may comprise generating mean and standard deviation values for each data of the workload dataset; generating uniform and non-uniform splines for curve fitting the mean and standard deviation values; and generating fixed and variable theta values at given times by applying stochastic differential equation (SDE) to the observed workload values, mean splines values, standard deviation spline values and Weiner process at the given times.

### RELATED APPLICATION

This application claims the benefit of provisional patent application Ser. No. 62/633,376, filed Feb. 21, 2018, the disclosure of which is hereby incorporated herein by reference in its entirety.

### TECHNICAL FIELD

The present disclosure relates to a generic workload modeling process of resource consumption in a virtualized system, fitting static, dynamic, predictive and non-predictive workloads.

### BACKGROUND

With the rise of Cloud computing in the last decade, there has been an increasing amount of research being conducted to help Cloud providers improve their systems performance, energy efficiency and quality of service (QoS). To achieve this goal, a common practice is to evaluate a system's workload. The notion of predictive workload denotes a “normal” and continuous usage of system resources. A non-predictive workload, on the other hand, is one which is triggered by a short, unexpected and extreme event. It can be, for example, a surge in calls being processed by an internet protocol (IP) multimedia subsystem (IMS) system during an earthquake. In the context of Cloud computing, this is an important factor to consider since it has an impact on how to handle resource allocation. Different methodologies and allocation decisions based on both workload types have been proposed in the literature. In the presence of predictive workload, for example, an algorithm was designed to provoke a virtual machine (VM) migration only if the fixed threshold is violated for a sustained time. In the presence of non-predictive workload, on the other hand, VM migration took place when the utilization was above a fixed threshold value. The use of predictive workload data may be preferred for building workload models where a user wishes to forecast future load, while non-predictive workload data may be preferred for building workload models where there are sharp, critical spikes in load variations that might impact the system.

One of the many challenges that arise when aiming to evaluate Cloud system policies, is the ability to get reliable data and tracelogs from organizations hosting Cloud environments as authentic industrial-grade workload data is sparse and often incomplete. To circumvent this issue, workload modeling is introduced as a good alternative, enabling to generate large numbers of workload profile data.

Many workload modeling solutions exist today, but none of them answers the needs to get a general purpose, generic modeling algorithm that can fit different types of telecom and information technology (IT) workloads. Current workload models are limited to specific domains as they are built on top of users' and applications' behaviors. While this might sound adequate for a single web server where the number and type of applications running are limited, this is not the case in a Cloud environment where a wider range of heterogeneous applications are running and many users have access to these resources. The workload model must adapt to the evolution in the system's configuration parameters like the jobs' load or shutting down certain central processing unit (CPU) cores.

Such critical dilemmas raise the need to generate generic workload models: which are independent of the user's behaviors and applications running in the system, and able to fit any workload domain and type; with high degree of fidelity with respect to the observed data in a low execution time; and able to overcome sharp workload variations.

Workload modeling is therefore a crucial component of evaluation tools in the field of Cloud computing, enabling performance evaluation and simulation of different attributes such as CPU, random access memory (RAM) and network traffic in a “black box” system. Workload models are commonly used by Cloud providers to analyze resource management policies aiming to enhance their systems' QoS before their deployment in full-scale production environments. This provides a controlled input, allowing workload adjustments to fit particular situations, repetition of evaluation conditions and inclusion of additional features. Furthermore, workload simulation based on realistic scenarios enables the generation of tracelogs, scarce in Cloud environments because of business and confidentiality concerns.

Workload modeling and workload generation are challenging, especially in Cloud systems, due to multiple factors: (i) workloads are composed of various tasks and events submitted at any time, (ii) heterogeneous hardware in a Cloud infrastructure impacts task execution time and arrival time and (iii) the virtualization layer of the Cloud infrastructure incurs overhead due to additional input/output (I/O) processing and communications with the virtual machine monitor (VMM). These factors make it difficult to design workload models and workload generators fitting different workload types and attributes. In the current state of the art, efforts are instead deployed to design specialized workload modeling techniques focusing mainly on specific user profiles, application types or workload attributes.

A goal of workload modeling is to be able to create workloads that can be used in performance evaluations. The objective is to get a workload model as close as possible to the real workload being synthesized. It starts with measured data about the workload and is a common alternative to using the traced workload directly to drive simulations.

The most common approach in the art to generate a workload model is to create a statistical summary of an observed workload. This summarization is then applied to all the workload attributes (e.g., CPU, memory usage, I/O, etc.), then distributions are fit to the observed values of the different parameters.

Other existing approaches have proposed workload prediction using linear regression, Neural Networks, Kalman filter and support vector regression (SVR.).

The existing workload modeling solutions do not answer the need to get a general purpose, generic modeling algorithm that can fit different types of telecom and IT workloads. Current workload models are limited to specific domains as they are built on top of users' and applications' behaviors. Moreover, the current workload models do not adapt well to the evolution in the system's configuration parameters like the job's load or shutting down certain CPU cores. Furthermore, current solutions do not offer a high fidelity in workload estimation with respect to the expected low execution time some simulations might require.

### SUMMARY

To address the limitations of existing workload modeling approaches, a novel workload modeling algorithm, which is generic enough to be applied to any workload domain, fits a system's behavior instead of the users' or applications', adapts to the evolution in a system's configuration parameters and offers high-fidelity workload estimations with a low execution time, is proposed.

Workload modeling appears in many contexts and therefore has many different types. For planning to evaluate specific workloads it is necessary to understand (a) what domains, (b) types and (c) attributes of workloads should be investigated, also, (d) if it is taking the shape of a static or dynamic rate of events and (e) if the workload is predictive or non-predictive. These concepts will be explored herein.

Two approaches for workload estimation are proposed herein. The first approach is a combination of Hull-White and genetic algorithm (GA), while the second one is a combination of support vector regression (SVR) and Kalman-filer. Thorough experiments are conducted on different real datasets to study the efficiency of both propositions. The results show higher accuracy for the Hull-White-GA approach with additional marginal overhead over SVR-Kalman-Filter combination.

In order to accurately estimate any attribute of workload (ex: CPU, RAM, I/O) from any domain, a hybrid workload modeling and optimization approach is proposed. It consists first of modeling workload data sets by using different Hull-White modeling processes. The observed workload is evaluated to generate continuous splines and estimate a drift value, which in turn become parameters for the Hull-White models. The second mechanism then uses a custom Genetic Algorithm to determine an optimal estimated workload solution.

There is provided a method, wherein the input data is considered as observed resource utilization data collected from the system, as a discrete time series of variable size. This data is split into discrete, uniform sets of data samples in order to evaluate mean and standard deviation values. This enables the generation of uniform and non-uniform splines from mean and standard deviation values, thus generating four different splines from a data set. This also enables the evaluation of a fixed and variable estimated parameter (θ). For fixed θ, the whole dataset is taken and a single θ value is calculated. As for variable θ, windows are made depending on the variation of the data.

The method further leverages the Hull-White process, wherein a stochastic differential equation is used to estimate realistic workload profiles for virtualized systems, based on the metrics evaluated previously, namely, the observed workload data, the uniform and non-uniform mean splines, the uniform and non-uniform standard deviation splines and, finally, fixed and variable θ values. Four Hull-White models are generated with varying degrees of fidelity to the behavior and observed workload values of a dataset.

The method further considers the Hull-White models generated previously. The workload estimation technique is enhanced by a Genetic Algorithm (GA) to dynamically generate optimized solutions according to a Mean Absolute Percentage

Error (MAPE) evaluation between the estimated workload and the observed workload. The Hull-White models are divided into an increasing number of segments of size 2h, where h is a number of decimal values allowing mutation and crossover of estimated workload of smaller size.

There is provided a method for estimating workload, comprising generating a workload model from observed workload data; generating at least two intermediate workload predictions using the workload model; and applying a genetic algorithm (GA) to the at least two intermediate workload predictions to generate a final workload prediction.

There is provided an apparatus for estimating workload, comprising processing circuitry and a memory, the memory containing instructions executable by the processing circuitry whereby the apparatus is operative to execute any one of the methods provided herein.

There is provided an application instance for estimating workload, in a cloud computing environment which provides processing and interface circuitry and memory for running the application instance, the memory containing instructions executable by the processing circuitry whereby the application instance is operative to execute any one of the methods provided herein.

The methods presented herein are not limited to virtualized systems; and may be extended to any monitored system that is able to provide data on its state.

The following advantages may be provided by at least some of the embodiments described herein.

The modeling algorithm is generic enough to be applied to any system since it is able to provide estimations without any prior knowledge or assumption on the system or its behavior thanks to the usage of different Hull-White models based on mean and standard deviation splines and a Genetic Algorithm. The modeling approach therefore is fit for any workload domain (e.g., Telecom, IT) and any workload attribute (e.g., CPU, RAM, I/O).

The modeling algorithm, being a combination of Hull-White processes and a Genetic Algorithm, automates the selection of short-term estimated workload solutions through different models and reduces user input.

A Genetic Algorithm reinforces the Hull-White process and optimizes the workload models by selecting the fittest solutions through many generations.

The modeling algorithm significantly improves execution time compared to other types of workload estimation models (ex: auto-regression, moving average, SVR, SVR with Kalman filter).

The modeling algorithm allows on-demand workload profile changes in a simulation thanks to adaptable and continuous spline functions.

The workload models are defined without requiring knowledge of the inner behaviors of the modeled systems (i.e. “black box” approach).

The workload profile data can be generated while limiting dependence on external organizations for providing such data, and the generated data can be used for training Artificial Intelligence (AI) based models.

The method provided herein present improvements to the way method for workload modeling operate.

### BRIEF DESCRIPTION OF THE DRAWINGS

FIG. 1a is a block diagram showing the main components of the modeling algorithm according to an example embodiment.

FIG. 1b is a schematic illustration of the workload modeling process according to an example embodiment

FIG. 2 is a diagram illustrating individuals and segments according to an example embodiment.

FIG. 3 is a diagram illustrating a selection process according to an example embodiment.

FIG. 4 is a diagram illustrating a crossover operation according to an example embodiment.

FIG. 5 is a diagram illustrating a mutation operation according to an example embodiment.

FIG. 6 illustrates a load modeling genetic algorithm (GA) according to an example embodiment.

FIG. 7 illustrates a Kalman Filter—support vector regression (SVR) algorithm according to an example embodiment.

FIG. 8 is a graph illustrating IMS Hull-White models: Observed data, μ(t), σ(t) according to an example embodiment.

FIG. 9 is a graph illustrating IMS: observed CPU workload according to an example embodiment.

FIG. 10 is a graph illustrating IMS: estimated CPU workload-GA according to an example embodiment.

FIG. 11 is a graph illustrating Google85 CPU workload model: Hull-White-GA vs observed data according to an example embodiment.

FIG. 12 is a graph illustrating ETS Web CPU workload model: Hull-White-GA vs observed data according to an example embodiment.

FIG. 13 is a pair of graphs illustrating IMS1: SVR and Kalman SVR according to an example embodiment.

FIG. 14 is a pair of graphs illustrating IMS2: SVR and Kalman SVR according to an example embodiment.

FIG. 15 is a pair of graphs illustrating IMS3: SVR and Kalman SVR according to an example embodiment.

FIG. 16 is a pair of graphs illustrating Google85: SVR and Kalman SVR according to an example embodiment.

FIG. 17 is a pair of graphs illustrating ETS Web: SVR and Kalman SVR according to an example embodiment.

FIG. 18 is a schematic illustration of a cloud environment in which embodiments can be deployed.

FIG. 19 is a flowchart of a method according to an example embodiment.

### DETAILED DESCRIPTION

Various features and embodiments will now be described with reference to the figures to fully convey the scope of the disclosure to those skilled in the art.

Many aspects will be described in terms of sequences of actions or functions. It should be recognized that in some embodiments, some functions or actions could be performed by specialized circuits, by program instructions being executed by one or more processors, or by a combination of both.

Further, some embodiments can be partially or completely embodied in the form of computer readable carrier or carrier wave containing an appropriate set of computer instructions that would cause a processor to carry out the techniques described herein.

In some alternate embodiments, the functions/actions may occur out of the order noted in the sequence of actions or simultaneously. Furthermore, in some illustrations, some blocks, functions or actions may be optional and may or may not be executed; these are generally illustrated with dashed lines.

As stated previously, there is a need to design tools for evaluating and enhancing different Quality of Service (QoS) aspects of Cloud systems, mainly performance, availability and reliability. Failing to comply to such aspects can compromise service availability and incur Service Level Agreement (SLA) violations and hence impose penalties on cloud providers. The development of system management policies that support QoS is therefore crucial. However, the latter is a challenging task, as it must rely on evaluation tools which are able to accurately represent the behavior of multiple attributes (e.g., CPU, RAM, network traffic) of Cloud systems. It is also complicated by the essence of Cloud systems, which observe varying demand and have heterogeneous physical infrastructures; these systems have different physical resources and network configurations and different software stacks. Further, the reproduction of conditions under which the system management policies are evaluated and the control of evaluation conditions are challenging tasks.

In this context, workload modeling enables performance evaluation and simulation as a “black box” system. Workload models allow Cloud providers to evaluate and simulate resource management policies aiming to enhance their systems' QoS before their deployment in full-scale production environments. It also provides a controlled input, allowing workload adjustments to fit particular situations, repetition of evaluation conditions and inclusion of additional features. Furthermore, workload simulation based on realistic scenarios enables the generation of tracelogs, scarce in Cloud environments because of business and confidentiality concerns.

As also stated previously, workload modeling and workload generation are challenging, especially in Cloud systems, due to multiple factors: (i) workloads are composed of various tasks and events submitted at any time, (ii) heterogeneous hardware in a Cloud infrastructure impacts task execution time and arrival time and (iii) the virtualization layer of the Cloud infrastructure incurs overhead due to additional I/O processing and communications with the Virtual Machine Monitor (VMM). These factors make it difficult to design workload models and workload generators fitting different workload types and attributes.

To tackle the above issues, a hybrid workload modeling and optimization approach to accurately estimate any attribute of workload, from any domain, is proposed. An objective is to develop realistic CPU workload profiles for different virtualized telecom and IT systems, based on data obtained from real systems.

This is achieved by modeling workload data sets by using different Hull-White modeling processes, and then determining an optimal estimated workload solution based on a custom genetic algorithm (GA).

A combination of Kalman filter and support vector regression (SVR) is also proposed to estimate workloads. The IMS workloads include three variations of the same load profile, where CPU workload is generated by stressing a virtualized IMS environment with varying amounts of calls per second, thus producing sharp increases and decreases in CPU workload over long periods of time.

The IT workloads take two different approaches. The Google CPU workload under evaluation, for example, is composed of sharp spikes of CPU workload variations over short periods of time. Another CPU workload, namely ETS web, on the other hand, is characterized with periodicity trends. All of these datasets therefore display unique trends and behavior that offer interesting scenarios to evaluate the efficiency of the workload modeling and workload generation techniques that are proposed herein.

The evaluation of the mean absolute percentage error (MAPE) of the best estimated data provided by the Hull-White based approach against the observed data, shows significant improvement in the accuracy level compared to other workload modeling approaches such as standard SVM and the SVM with a Kalman filter.

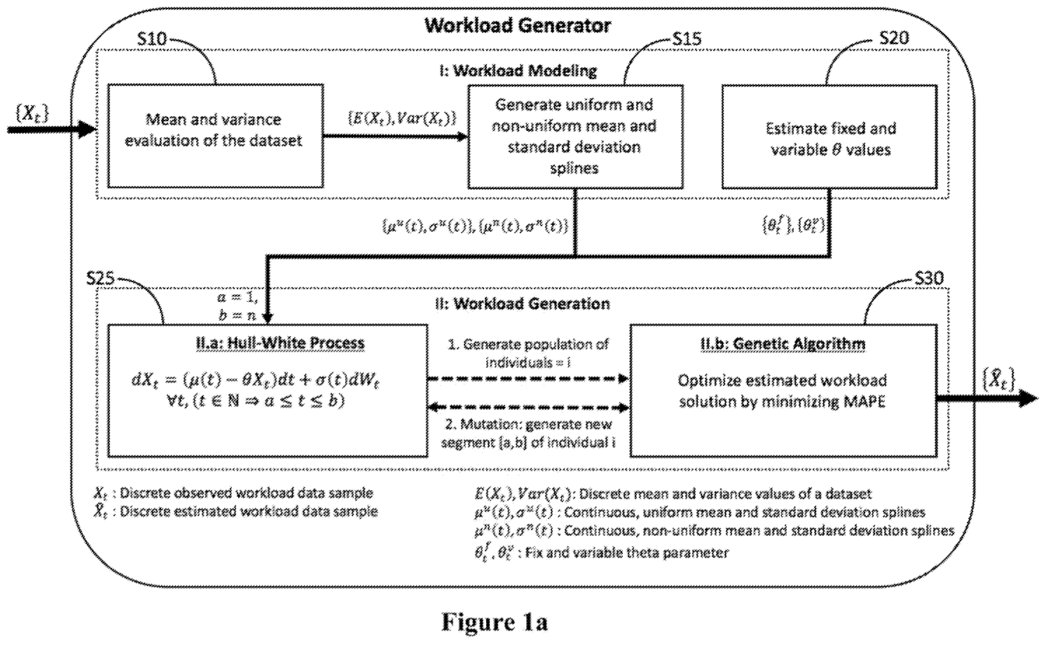

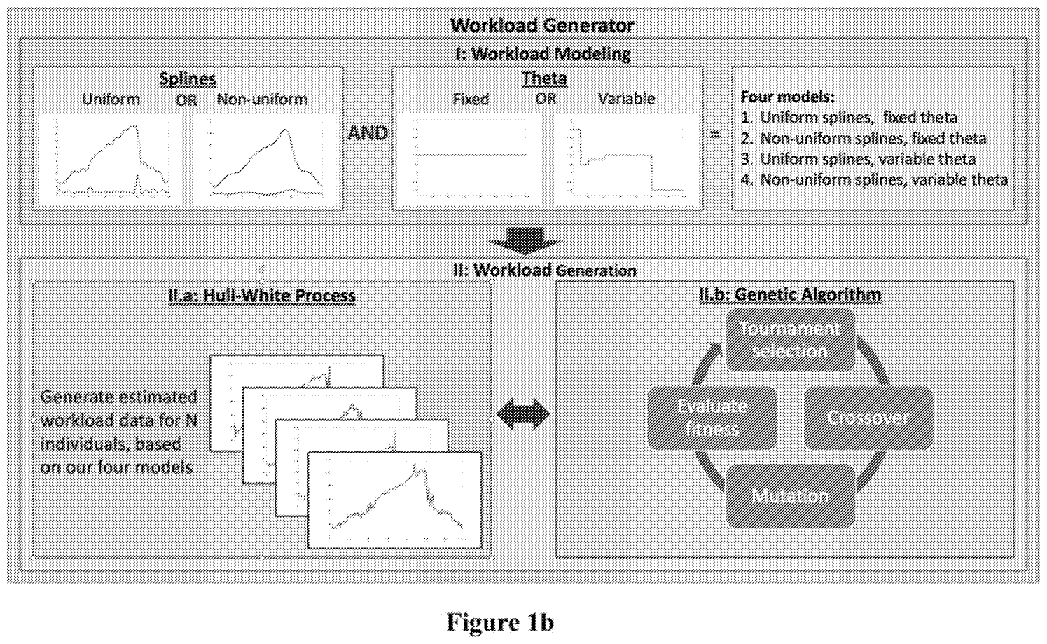

FIG. 1a illustrates an example showing the modeling of a case of time-series data of the resource consumption in virtualized systems.

The workload modeling algorithm starts by reading the collected observed workload data from a system. It then evaluates the collected dataset to get discrete mean and variance values, step S10, in a sequential and uniform manner that faithfully represents the workload behavior in the whole time series.

Based on the mean and variance values of the dataset, uniform and non-uniform splines are generated, step S15: one model will use the uniform splines generated from the mean and variance values, thus creating a {μ^{u} (t), σ^{u}(t)} core model. Another model will use the non-uniform splines generated from the same mean and variance values, thus creating a {μⁿ (t), σⁿ(t)} core model.

Concurrently to step S10, a fixed θ value (θ^{f}) value is estimated along with variable θ values (θ^{v}), based from an analysis of sharp variations and periodicity in the observed workload, step S20. While the μ and σ values alone are sufficient to generate basic stochastic differential equation (SDE) models, the θ values are a key feature of the Hull-White process, as it adds drift to the estimation process, thus adding a more realistic behavior to the estimated workload with a significantly low impact on execution time.

Following steps S15 and S20, four (4) different models are obtained based on different combinations of μ, σ and θ values:

Model 1: {μ^{u}(t), σ^{u}(t), θ^{f}(t)}

Model 2: {μⁿ(t), σⁿ(t), θ^{f}(t)}

Model 3: {μ^{u}(t), σ^{u}(t), θ^{v}(t)}

Model 4: {μⁿ(t), σⁿ(t), θ^{v}(t)}

After evaluating all the necessary parameters of the Hull-White process, the workload modeling algorithm then proceeds to generate a set number of “individuals” (an individual is a full workload estimation based on one of the four models mentioned above), step S25.

The final step, step S30, involves an optimization process using a Genetic Algorithm (GA). Through a set number of generations, individuals generated at the previous step (step S25) or from previous generations get randomly selected through a tournament selection process. From this tournament selection process, two of the fittest individuals become candidates for crossover operations. The crossover operations occur until a set number of solutions are generated for the next cycle. Next, a mutation process selects segments from an individual according to a mutation rate, and that segment is re-generated from the Hull-White process, from a random model (step S25). The Genetic Algorithm continues repeatedly for a set number of generations, and the fittest individual becomes the output solution of estimated workload.

Workload Generator Architecture

FIG. 1b illustrates the relationship between (1) the Hull-White workload modeling process and (2) a custom Genetic Algorithm (GA) involved in the workload generation and optimization process.

For Hull-White modeling, the mean and standard deviation of an observed workload data set is estimated in a chronologic order. To get smooth and continuous functions of mean and standard deviation, the workload generator employs uniform and non-uniform quadratic spline curves. Next, fixed and variable theta values are estimated. The full process of Hull-White modeling is explained further below. The amount and boundaries of both non-uniform splines and variable thetas are evaluated in an entirely automated process of the workload generator. The latter sets boundaries where there are great variations in mean values and/or standard deviation over a short period of time. Thus, four different Hull-White models are obtained, from which workload data is generated, namely: (1) model of uniform splines and fixed theta, (2) model of uniform splines and variable theta, (3) model of non-uniform splines and fixed theta and (4) model of Non-uniform splines with variable theta.

On its own, the Hull-White modeling process proves to be an efficient algorithm to estimate workload data. However, by enforcing Hull-White modeling with a custom GA optimization, experiments demonstrate that the Mean Absolute Percentage Error (MAPE) of the estimated data generated is significantly improved with minimal impact on the execution time. That proves to be especially true when pairing the benefits of the GA with the four afore-mentioned Hull-White models, each one providing different levels of fidelity and excelling in different areas.

To build workload models, discrete observed workload data must first be provided as an input to the workload generator. That workload data is then processed, and four Hull-White workload models are then automatically generated. These models can be saved under a workload profile specified by a user. Next, a workload profile can be used in full or in part of a workload generation process. A user may have an opportunity to shift system parameters during a simulation, given the corresponding workload profile exists. Finally, the custom GA generates estimated workload data from many instances of the according workload profile(s) and selects the fittest solutions, which can be proposed to a user.

Hull-White Workload Modeling

In this section, the formulation of the workload modeling problem and its underlying processes is presented. The main objective of this process it to develop realistic workload profiles for different virtualized telecom and IT systems, based on data obtained from real systems, without requiring knowledge of their inner working processes (Black-box approach).

From each four values of the real data, mean and standard deviation values are generated. Stochastic differential equations (SDEs) are an excellent choice to model the time evolution of dynamic systems subject to random changes:

dXₜ=μ(t)dt+σ(t)dWₜ,t≥0 (1)

Where:

Xₜ: Observed workload

μ(t): Mean value of observed workload at time t

σ(t): Variance value of observed workload at time t

Wₜ: Weiner process

Next, Spline are generated for curve-fitting continuous mean μ(t) and continuous standard deviation σ(t) values. Splines are used to estimate the mean μ(t) and standard deviation σ(t) of a set of workload data in order to achieve smooth and continuous functions. Both uniform and non-uniform splines are used. The uniform splines use knots (aka “anchor points”) set at regular time intervals (ex: one knot every 20 seconds), while non-uniform splines use knots set at irregular time intervals.

$$\hat{f} ( {X}_{r} ( t ) ) = \{ \begin{matrix}{a}_{i} {t}_{i - 1}^{2} + {b}_{i} {t}_{i - 1} + {c}_{i - 1} = \hat{f} ( {X}_{i - 1} ) \\ {a}_{i} {t}_{i}^{2} + {b}_{i} {t}_{i} + {c}_{i} = \hat{f} ( {X}_{i} ) \\ {a}_{i} {t}_{i + 1}^{2} + {b}_{i} {t}_{i + 1} + {c}_{i + 1} = 0\end{matrix} i = 1 , … , q$$

Where:

α₁=0 First linear Spline

\hat{f}(Xₜ(t))=μ(t) Continuous mean

Or \hat{f}(Xₜ(t))=σ(t) Continuous standard deviation

The following describes the main properties of the Hull-White model, which is a popular choice of stochastic differential equation (SDE) in the finance sector for modeling future interest rates.

dXₜ=(μ(t)−θXₜ)dt+σ(t)dWₜ,t≥0 (2)

Where:

Xₜ Observed workload

μ(t) Mean spline value of observed workload at time t

σ(t) Standard deviation spline value of observed workload at time t

θ Estimated parameter

Wₜ Weiner process

The parameter theta θ is a key feature of the Hull-White process. It is an estimated value that provides a drift to the estimated workload. The models are generated with both fixed and variable theta values. For fixed theta, the whole data is taken, and one theta value is calculated. As for variable theta, windows are made depending on the variations in the data.

$${L}_{t} ( θ ) = exp ( - {\int }_{0}^{T} \hat{u} ( t , {X}_{T} ) d {X}_{T} - \frac{1}{2} {\int }_{0}^{T} {\hat{u}}_{2} ( t , {X}_{T} ) dt ) Where : \\ \hat{u} ( t , {X}_{T} ) = \frac{μ ( t ) - θ {X}_{T}}{σ ( t )} \qquad ( 3 )$$

Therefore, the MLE is defined as

[symbol]

=argmax L_{T}(θ)

GA Workload Estimation

A genetic algorithm (GA) is a metaheuristic inspired by the process of natural selection. It belongs to the larger class of evolutionary algorithms (EAs) and is commonly used in computer science to generate optimized solutions to complex search problems. To achieve this goal, a GA relies on bio-inspired operators such as mutation, crossover and selection to simulate the propagation of fittest individuals over consecutive generations.

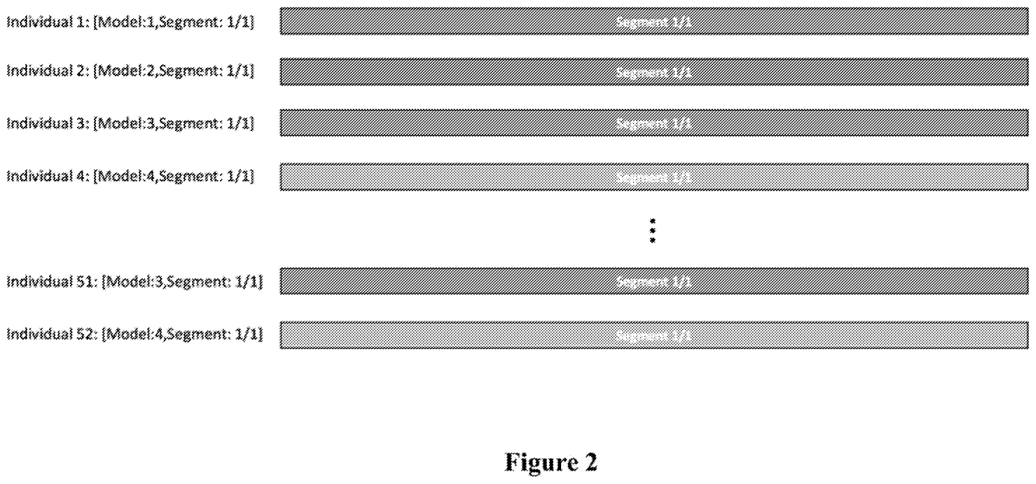

In GA, a population is a set of individuals that form potential solutions. For workload estimation, each of individual/chromosome is defined as a set of decimal values, of size 1. Each chromosome is an estimated workload value for the current workload attribute of the workload profile under evaluation. For instance, if the CPU attributes of an IMS workload profile is evaluated, each individual is composed of chronologically and randomly estimated CPU workload values provided by any of the defined Hull-White models, see for example FIG. 2 which is described below.

As illustrated in FIG. 2, an individual is divided into smaller segments, or genes, to go further in an evolution process of crossover and mutation operations. Each segment is of varying size and represents a portion of the individual. For instance, an individual of length L=100 may be divided into 4 even parts, hence creating 4 segments: segment 1 contains chromosomes 1 through 25, segment 2 contains chromosomes 26 through 50, etc.

In GA, a fitness function is required to rank individuals in the current population. The score of an individual depends on how close its estimated values are to the observed values of a workload profile. For the problem at hand, the fitness of an individual is evaluated by its mean absolute percentage error (MAPE) score:

$$M A P E = \frac{100}{r} {\sum }_{t = 1}^{r} \vert \frac{{X}_{t} - {\hat{X}}_{t}}{{X}_{t}} \vert \qquad ( 4 )$$

Where:

Xₜ Observed value

\hat{X}ₜ Estimated value

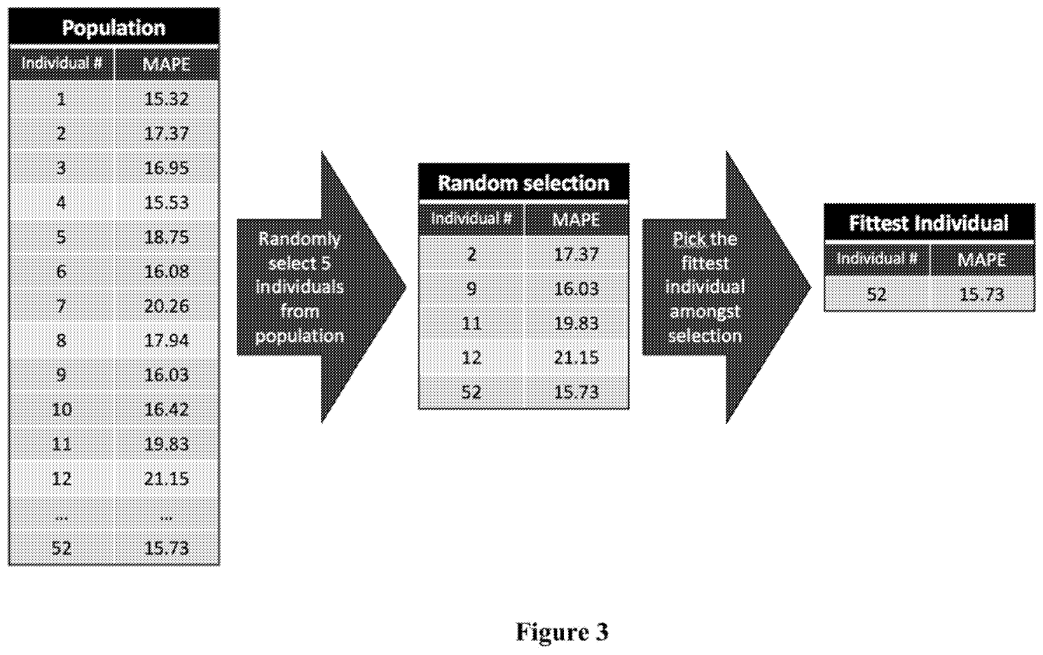

During each successive generation, a portion of the current population is selected to breed a new generation. One way for making the selection is through a tournament selection, as illustrated in FIG. 3. To do so, one candidate with the fittest solution amongst x randomly designated individuals is selected. The process is then repeated to select a second candidate. Both candidates become parents to generate a new offspring in the crossover operator.

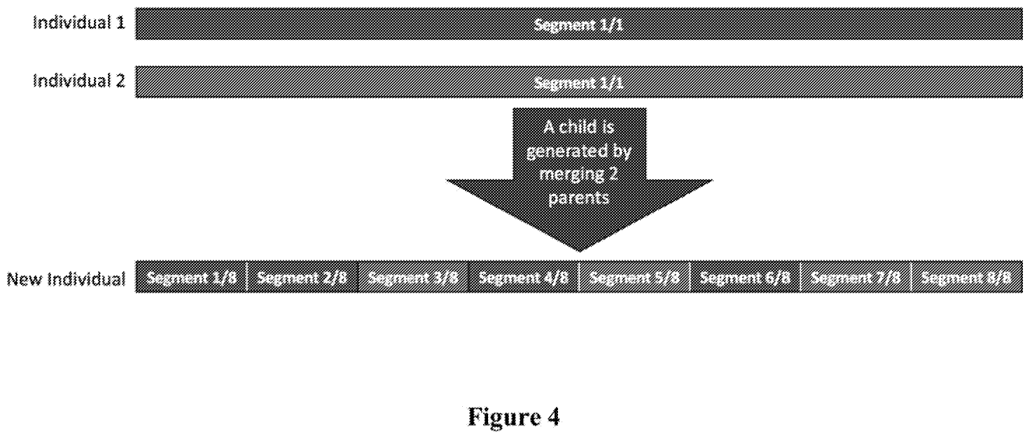

The crossover operator generates a next generation population of solutions from those selected through tournament selection. As shown in FIG. 4, segments are chosen randomly, based on a uniform rate of σ_{c}, from both parents I₁ and I₂ to generate a new offspring.

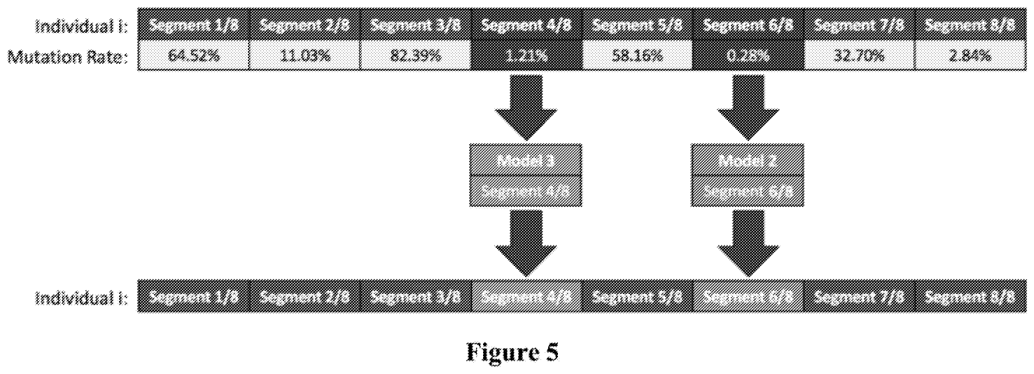

The mutation operator generates new estimated values from a randomly selected Hull-White model for randomly selected segments of an individual. It is based on a mutation rate of ρₘ. FIG. 5 depicts how new workload estimation values of segments 4/8 and 6/8 are modified during the mutation process.

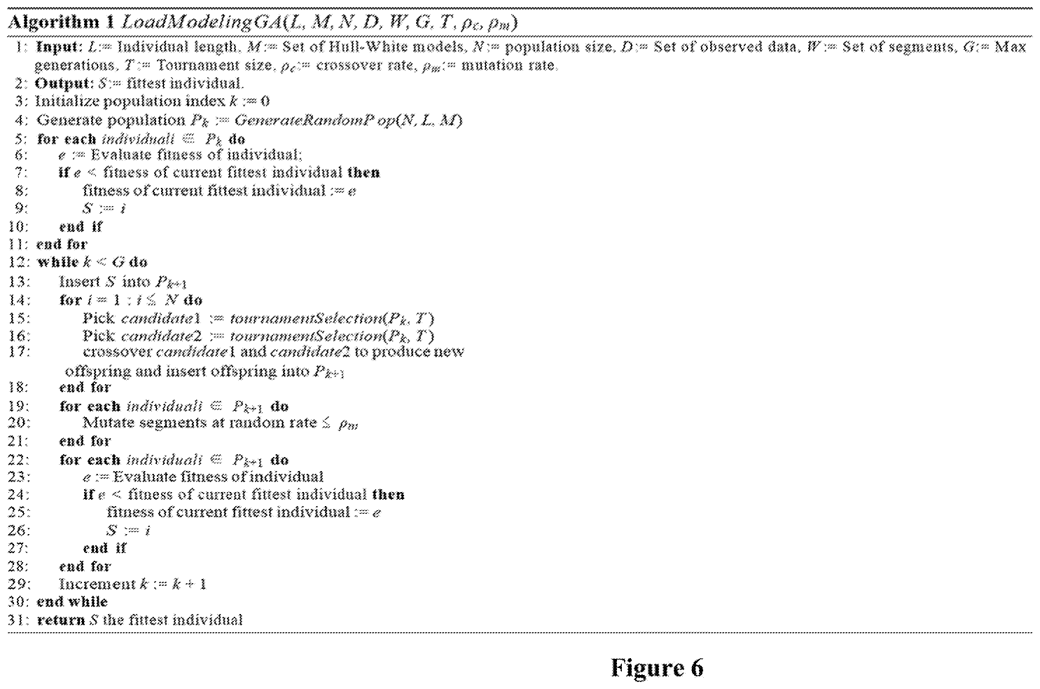

FIG. 6 illustrates an example algorithm for executing the process for workload modeling with GA. The algorithm starts by generating a random population of candidate workload values (Line 4) then evaluates the fitness function, which is the MAPE for each individual (Line 5 to 11). Afterwards, candidates are selected through a tournament process (Lines 15 and 16) to go into the evolution process of crossover (Line 17) and mutation (Line 20). The fitness of these individuals forming the new population is then calculated (Line 22 to 28). The process is repeated until the maximum number of generations is achieved. Finally, the algorithm returns the fittest individual having the least MAPE found throughout the generated populations (Line 31).

Kalman-SVR Workload Estimation

Kalman Filter is a well-known model to estimate a hidden state x of a system indirectly from measured data, while it can integrate data from as many measurements as available. The Kalman filter model is defined as follows:

Xₖ=Axₖ₋₁+Buₖ₋₁+wₖ₋₁ (5)

with a measurement z,

zₖ=Hxₖ+vₖ (6)

Where,

A Transition matrix from time k−1 to k

B Control matrix

uₖ-1 known vector

H Matrix showing the relationship between zₖ and xₖ

wk-1 and vk Process and measurement noise respectively

After filtering observed workloads with Kalman filter to remove the noise and hence minimize the prediction error, SVR is used to estimate workloads. In SVR, input data are separated into training data classes using linear hyperplanes. If the input data cannot be linearly separated, then input vectors (observed data) are mapped into high dimensional feature space using non-linear mapping function (kernel function). SVR identifies the optimal hyperplane that maximize the margin between the vectors of the considered classes. This optimal hyperplane is defined as a linear decision function (find optimal parameters w and b):

f(x)=w·K(x)+b (7)

Where:

x Input data, w is the weight vector and b the bias parameter

K(x) kernel function (e.g., linear, radial basis function (RBF))

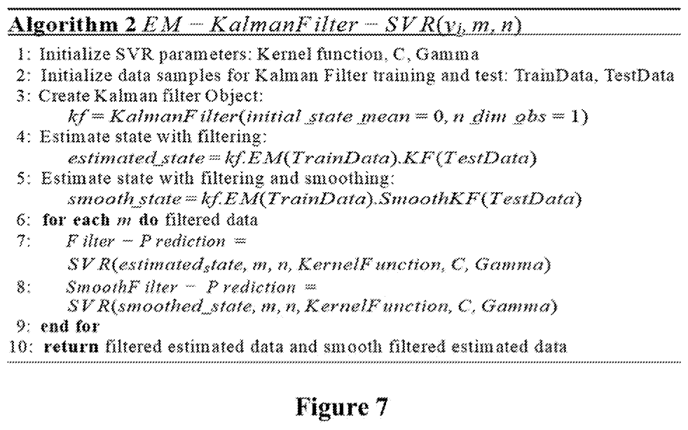

FIG. 7 illustrates an example algorithm for executing the proposed EM-Kalman Filter-SVR. The algorithm starts by initializing SVR parameters (Line 1). Kernel function model can be radial basis function (RBF), linear or polynomial. The C parameter trades off misclassification of training examples against simplicity of the decision surface while Gamma can be defined as the inverse of the radius of influence of samples selected by the model as support vectors.

Then another initialization phase is conducted for the data samples of the Kalman filter. Next the initial state mean is set to 0 while n_dim_obs which is the size of observation space, is set to 1 (Line 3). The estimated state is calculated using EM (Lines 4 and 5). Expectation-maximization algorithm or EM, is a meta-algorithm for learning parameters in probabilistic models. It aims to find parameters that maximize the expected likelihood of the observed variables. EM algorithm is used herein to estimate model parameters with the Kalman Filter. The algorithm estimates the state with the Kalman filter (Line 4) then estimate it with filtering and smoothing (Line 5). Afterwards, both estimated state and smoothed state are used in SVR for filter prediction and smooth filter prediction respectively (Lines 7 and 8). Finally, the algorithm returns the filtered estimated data and the smooth filtered estimated data (Line 9).

### Experimental Results

CPU workload from two different domains are used: IT and telecom. These workloads were selected because they differ significantly from each other and it allows evaluating the performance of the process under different load behaviors and displaying its general efficiency under various situations. For instance, IT CPU workloads show sharper variations in short bursts while telecom workloads, on the other hand, show flatter, continuous loads under normal customer demand. This is due to the way how CPUs handle the different jobs and tasks from each workload domain, as IT CPU loads imply distributed computing while telecom CPU loads generally imply individual call setup activity. Under critical, unexpected customer demand, however, telecom CPU loads will have dramatic variations and can impact the whole system having as a consequence that customer calls may be dropped. To cover as many scenarios as possible, 5 different datasets are used; 3 from the telecom domain (IMS1, IMS2, IMS3) which have a similar configuration, but with slight variations in the amount of customer's calls per second (CPS) generated, and 2 from the IT domain (Google85, ETS Web). The Google85 dataset comes from a single server in a Google cloud environment and shows a standard behavior of a CPU workload under normal utilization in a cloud environment. The ETS Web dataset comes from a virtual machine hosting a web server at Ecole de technologie superieure (ETS) and shows periodicity (cycles) under one week of normal utilization.

To demonstrate the proposed hybrid workload modeling approach, workload models were created based on observed CPU workload of virtualized IP Multimedia Subsystem (IMS) and Google clusters. The experiments were performed on a machine with a 2.3 GHz Intel Core i7 quad-core processor, 16 GB of RAM and running Matlab R2017a. The following describes the configurations and scenarios used.

Configuration IMS1: Starts at 150 CPS (calls per second), increment: 50 CPS/10 sec until 400 CPS; 400 CPS constant during 100 sec; 600 CPS constant during 300 sec; 200 CPS decrement: 50 CPS/50 sec until 50 CPS.

Configuration IMS2: IMS1+50 CPS.

Configuration IMS3: IMS1-50 CPS.

Configuration Google85: CPU load of a single machine in a cluster.

Configuration ETS Web: CPU load collected every 30 minutes from a virtual machine hosting a web server.

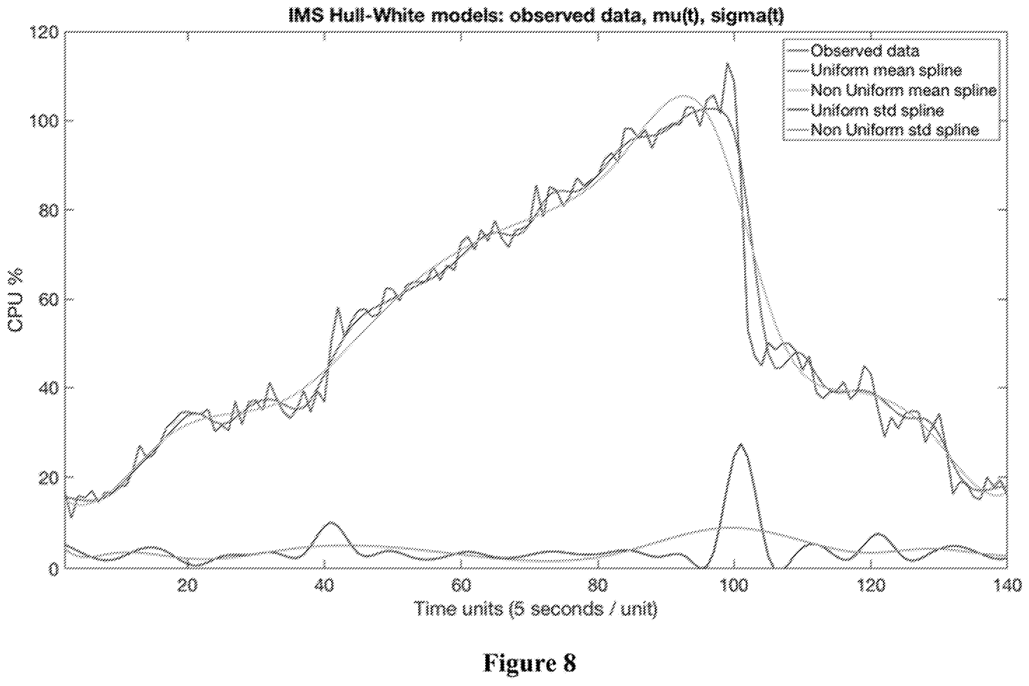

In the first set of experiments, four hull-white models were used for workload modeling and then estimated workloads were generated accordingly. In the second set of experiments, Hull-white with GA were combined, where the first one was used to model workloads and the latter was used to generate optimized workload estimation. FIGS. 8-12 depict the results for each dataset accordingly, while Table 1 illustrates the MAPE of the considered models to study their accuracy.

TABLE 1
Average MAPE of solutions based on 10 simulations

| | GA-Hull | Hull-White | Hull-White | Hull-White | Hull-White | | SVR- |
|---|---|---|---|---|---|---|---|
| Dataset | White | Model 1 | Model 2 | Model 3 | Model 4 | SVR | Kalman |
| IMS 1 | 3.7625 | 9.1578 | 10.8235 | 9.6495 | 10.8148 | 10.27 | 8.44 |
| IMS 2 | 3.931 | 10.1615 | 14.0743 | 9.4488 | 14.3537 | 9.56 | 7.81 |
| IMS 3 | 4.3163 | 10.6697 | 13.6215 | 10.7017 | 13.2126 | 11.15 | 7.48 |
| Google85 | 7.3226 | 18.5092 | 20.2361 | 17.7301 | 20.4648 | 19.19 | 5.82 |
| ETS Web | 5.3969 | 7.6307 | 9.0903 | 7.5744 | 9.1559 | 11.83 | 6.70 |

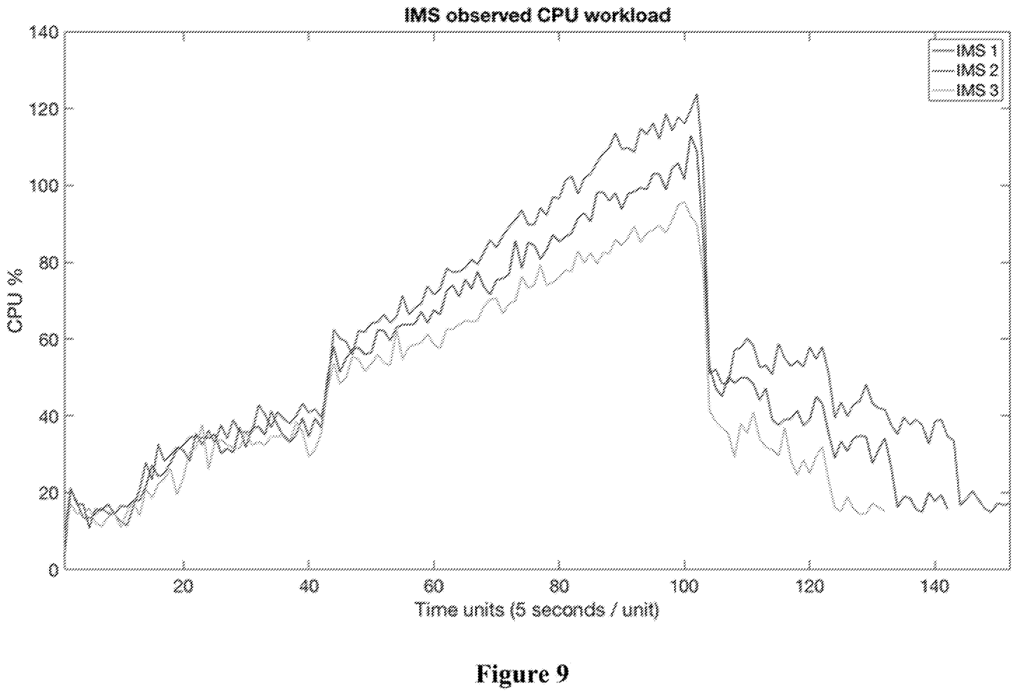

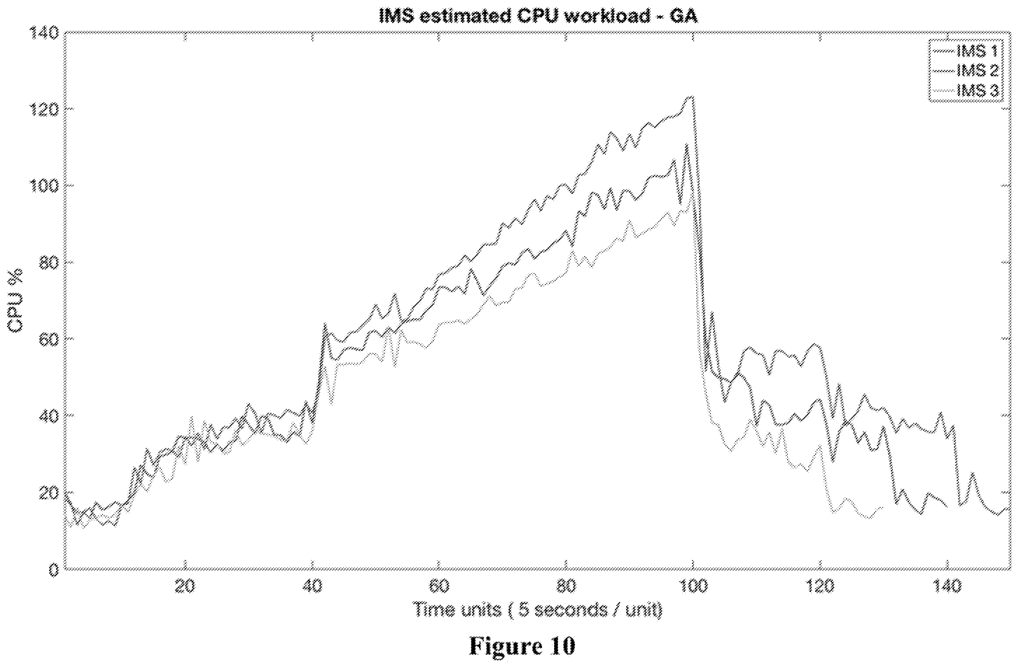

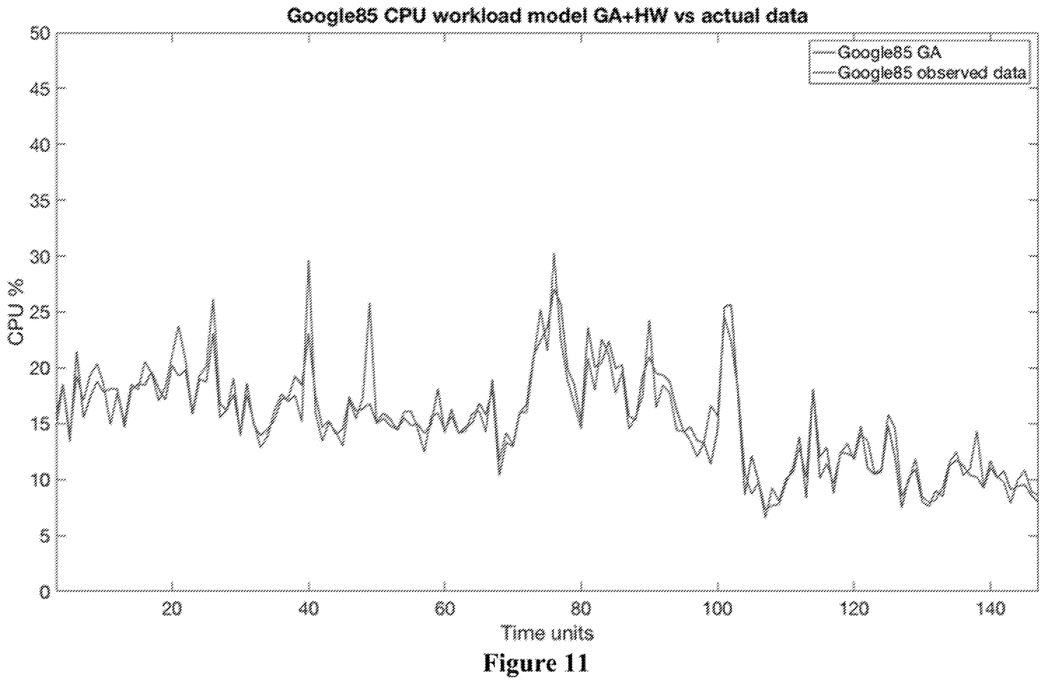

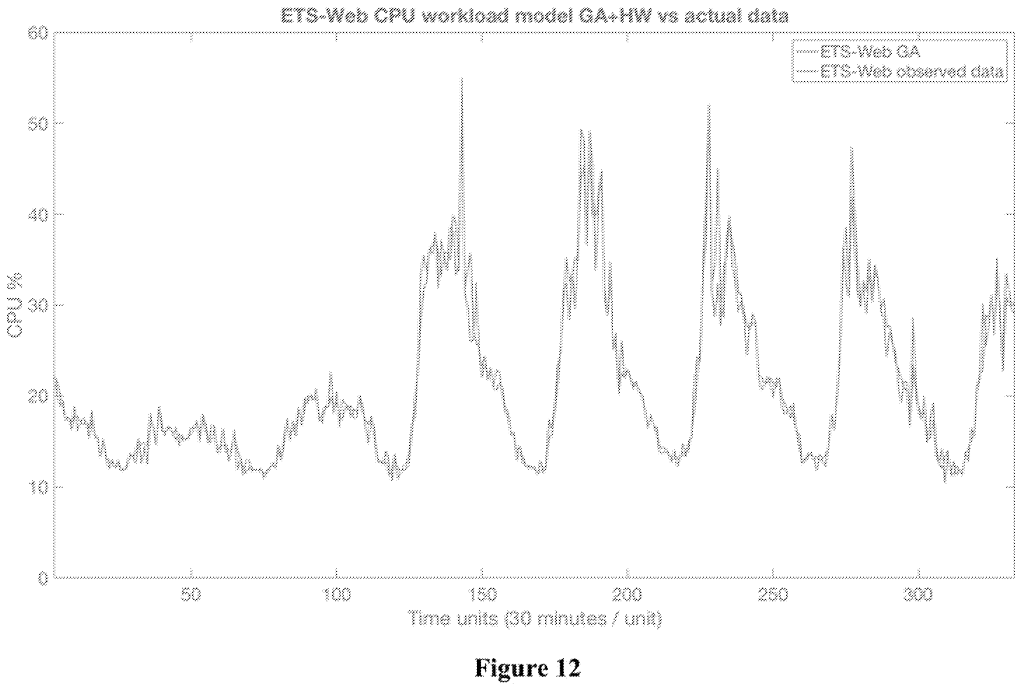

The results show that the Hull-White combined with GA is able to generate workloads with the highest fidelity for all tested datasets. From FIGS. 9 and 10, the estimated workload fits the observed workload, at the exception of some areas where there are sharp CPU increases/decreases. FIG. 11 shows that the estimated workload follows the same behavior as the observed workload. It should be noted, however, that the estimated workload is not an exact representation of the observed workload pattern. As for FIG. 12, in case of periodic workloads, a similar pattern is observed. The estimated workload behavior, however, needs improvement. This is especially noticeable in areas where there are sharp spikes.

Further, all these models were compared with support vector regression (SVR) and Kalman-SVR models. SVR allows data approximation based on statistical learning theory. In this SVR model, the prediction of future resource usage is based on observed data, which is divided into training and prediction sets to generate the estimated workloads. As for Kalman-SVR model, the observed data was filtered through the Kalman filter, then the model was predicted using SVR. For SVR, four observations were used to train the model and two observations were used to estimate the next two values. The kernel function is set to RBF since it is more appropriate to nonlinear dataset, while C and Gamma values are fixed to 0.1. These parameters are set through extensive tests performed in order to find a configuration that minimizes the estimation errors. As for Kalman filter, the transition is considered as an identity matrix, a vector of zero control input is assumed, and the noise measurement is of the state directly. Therefore, the following values were set A=1, u=0, and H=1 in equations 5 and 6, which are now define as follows:

xₖ=xₖ₋₁+wₖ₋₁ (8)

zₖ=xₖ+vₖ (9)

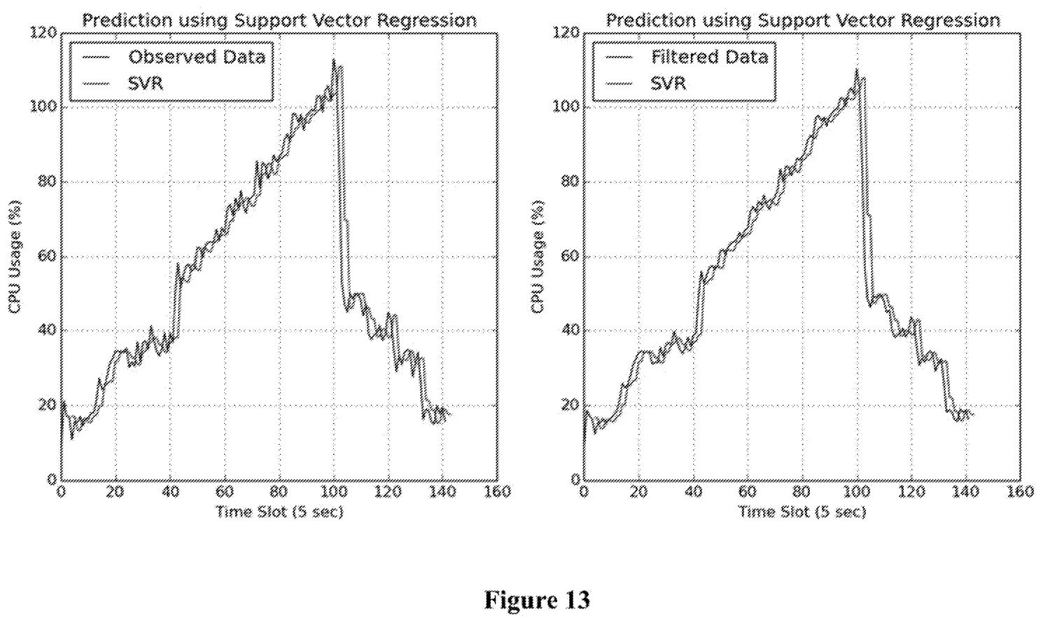

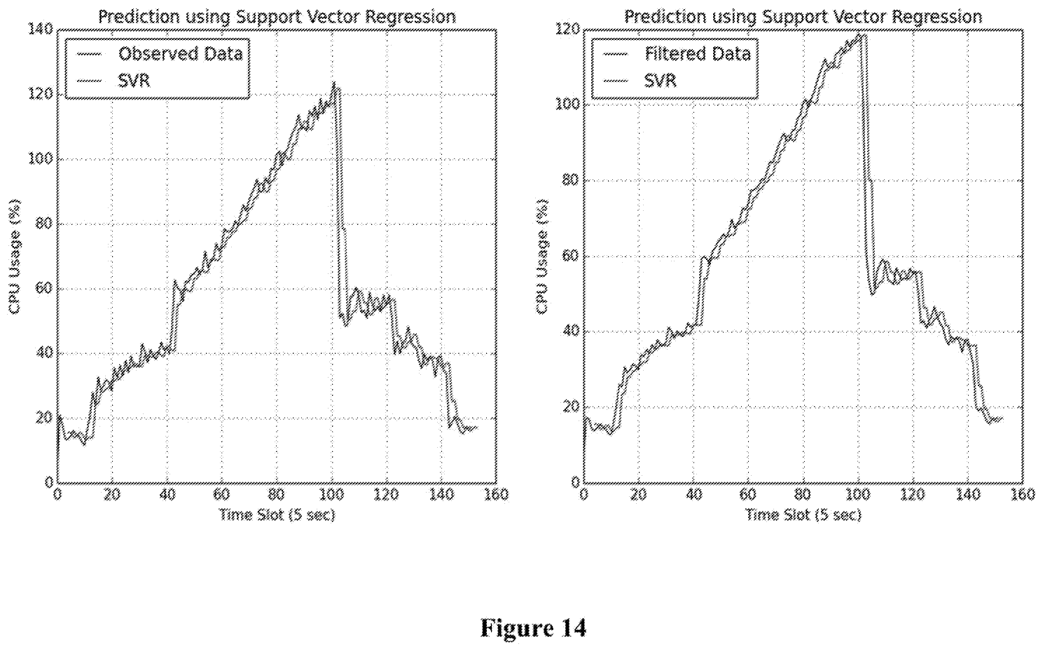

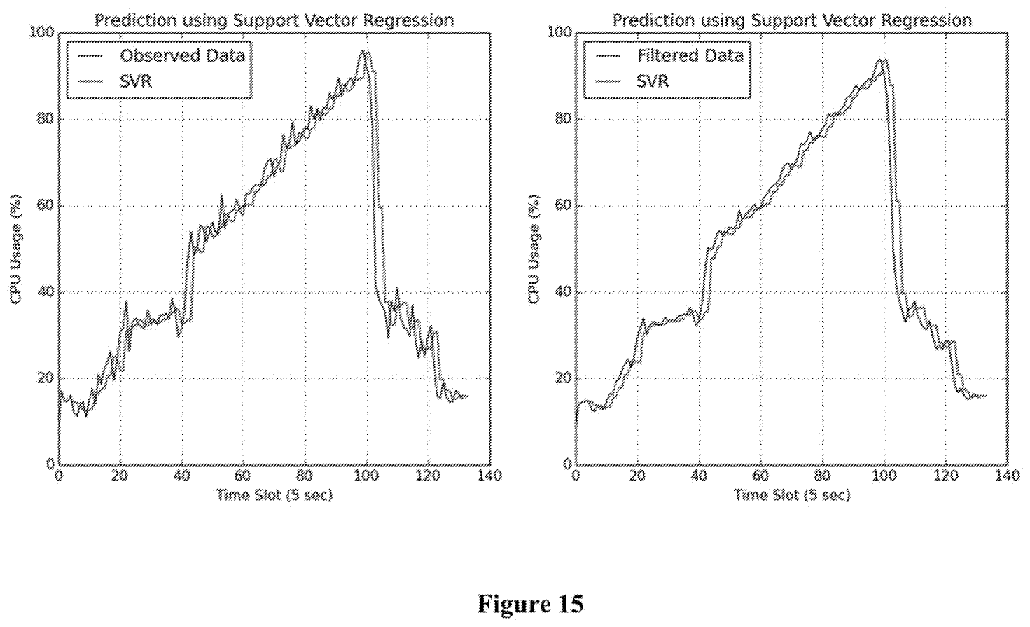

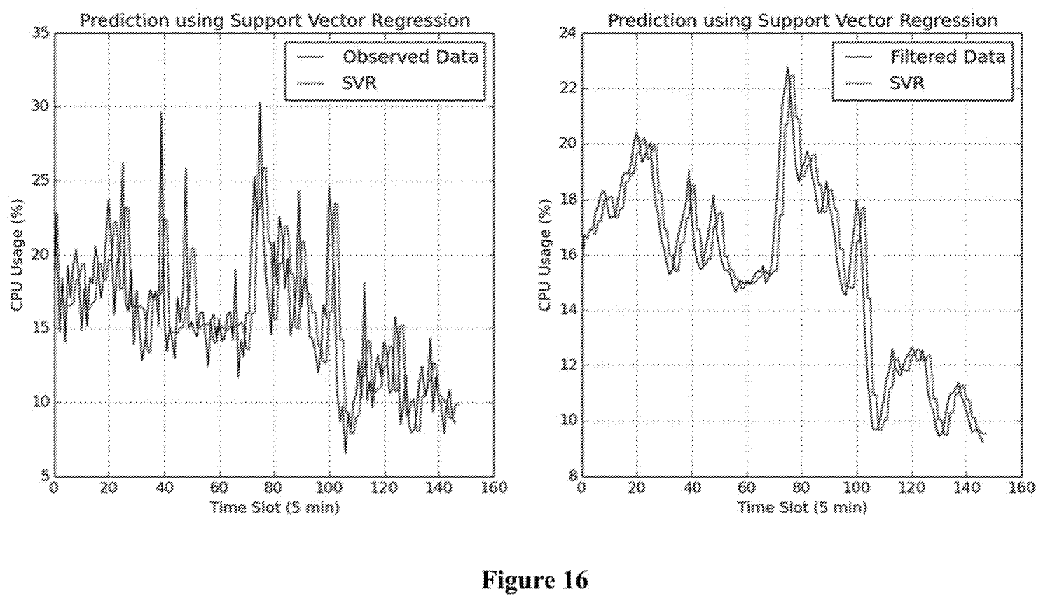

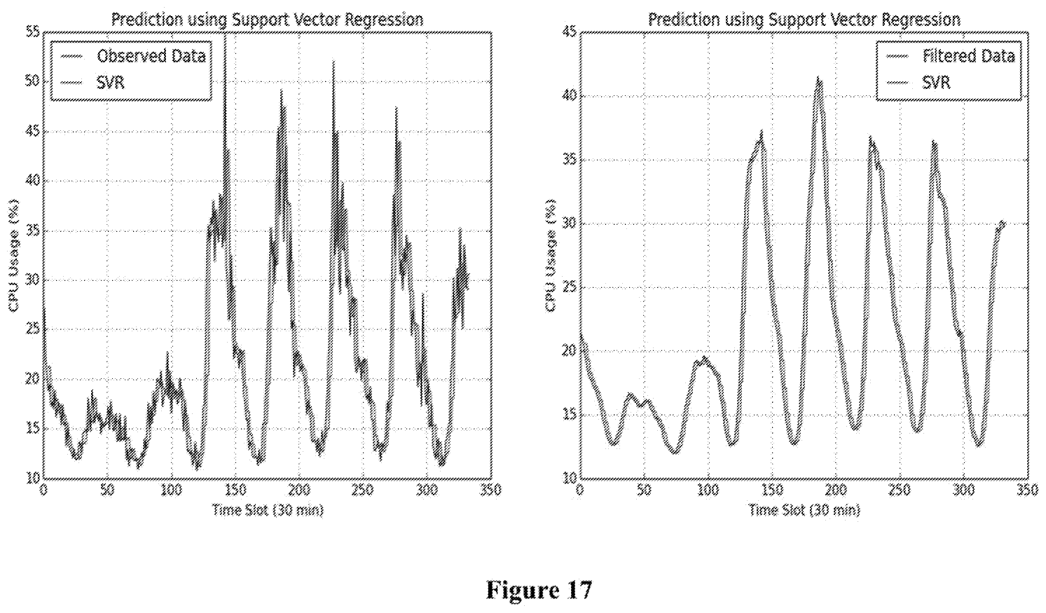

FIGS. 13-17 depict the results obtained. Comparing SVR with Kalman-SVR, Table 1 presented previously showed the efficiency of the latter to generate more accurate results in all the datasets. Yet, Hull-white-GA demonstrated its efficiency over SVR and Kalman-SVM showing higher accuracy for IMS and ETS Web datasets. As for Google CPU workload, Kalman-SVR shows better results with the least mean absolute percentage error.

In Table 2 the performance of all the studied models is compared. The results show that Kalman-SVR outperforms the other models in all the datasets.

TABLE 2
Average execution time(s) based on 10
simulations, 60 generations for GA

| | GA- | | |
|---|---|---|---|
| | Hull | | SVR- |
| Dataset | White | SVR | Kalman |
| IMS1 | 2.77 | 9.60*10⁻³ | 9.16*10⁻³ |
| IMS2 | 2.80 | 10.11*10⁻³ | 9.46*10⁻³ |
| IMS3 | 2.63 | 9.19*10⁻³ | 8.41*10⁻³ |
| Google85 | 2.88 | 9.81*10⁻³ | 8.99*10⁻³ |
| ETS Web | 4.16 | 22.04*10⁻³ | 21.46*10⁻³ |

To summarize, these experiments show that Hull-White combined with GA is able to provide the highest accuracy for Workload modeling and estimation yet with higher overhead in terms of execution time compared to Kalman-SVR. Yet the latter loses efficiency proportionally to the window size and is more sensitive to large variations and peaks in the observed workload data.

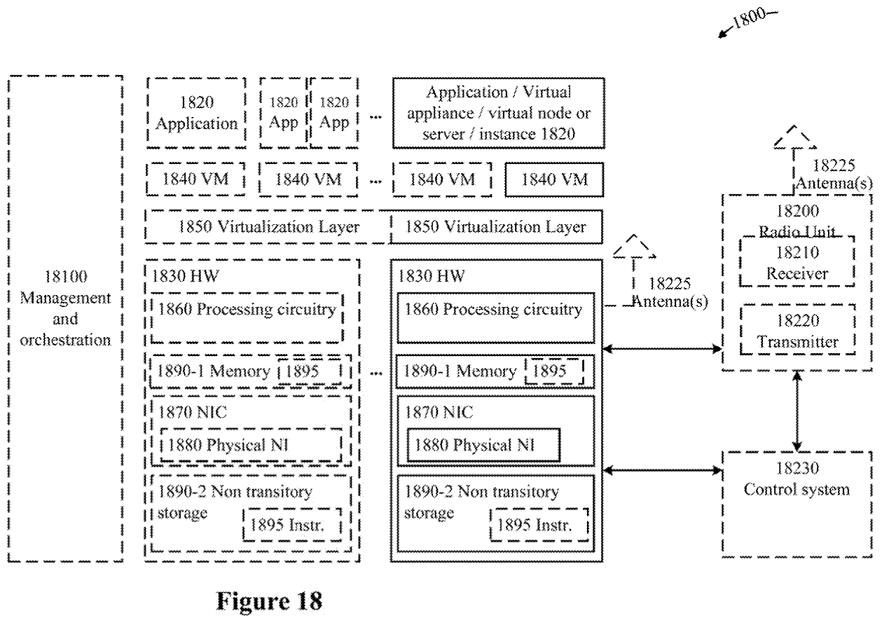

FIG. 18 is a schematic block diagram illustrating a virtualization environment 1800 in which functions implemented by some embodiments may be virtualized. As used herein, virtualization can be applied to a node (e.g., a virtualized base station or a virtualized radio access node) or to a device (e.g., a UE, a wireless device or any other type of communication device) and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines or containers implemented in one or more virtual environments 1800 hosted by one or more of hardware nodes 1830. Further, in embodiments in which the virtual node is not a radio access node or does not require radio connectivity (e.g., a core network node), then the network node may be entirely virtualized.

The functions may be implemented by one or more applications 1820 (which may alternatively be called software instances, virtual appliances, network functions, virtual nodes, virtual network functions, etc.) operative to implement steps of some methods according to some embodiments. Applications 1820 run in virtualization environment 1800 which provides hardware 1830 comprising processing circuitry 1860 and memory 1890. Memory 1890 contains instructions 1895 executable by processing circuitry 1860 whereby application 1820 is operative to provide any of the relevant features, benefits, and/or functions disclosed herein.

Virtualization environment 1800, comprises general-purpose or special-purpose network hardware devices 1830 comprising a set of one or more processors or processing circuitry 1860, which may be commercial off-the-shelf (COTS) processors, dedicated Application Specific Integrated Circuits (ASICs), or any other type of processing circuitry including digital or analog hardware components or special purpose processors. Each hardware device may comprise memory 1890-1 which may be non-persistent memory for temporarily storing instructions 1895 or software executed by the processing circuitry 1860. Each hardware devices may comprise one or more network interface controllers 1870 (NICs), also known as network interface cards, which include physical network interface 1880. Each hardware devices may also include non-transitory, persistent, machine readable storage media 1890-2 having stored therein software 1895 and/or instruction executable by processing circuitry 1860. Software 1895 may include any type of software including software for instantiating one or more virtualization layers 1850 (also referred to as hypervisors), software to execute virtual machines 1840 or containers as well as software allowing to execute functions described in relation with some embodiments described herein.

Virtual machines 1840 or containers, comprise virtual processing, virtual memory, virtual networking or interface and virtual storage, and may be run by a corresponding virtualization layer 1850 or hypervisor. Different embodiments of the instance of virtual appliance 1820 may be implemented on one or more of virtual machines 1840 or containers, and the implementations may be made in different ways.

During operation, processing circuitry 1860 executes software 1895 to instantiate the hypervisor or virtualization layer 1850, which may sometimes be referred to as a virtual machine monitor (VMM). Virtualization layer 1850 may present a virtual operating platform that appears like networking hardware to virtual machine 1840 or to a container.

As shown in FIG. 18, hardware 1830 may be a standalone network node, with generic or specific components. Hardware 1830 may comprise antenna 18225 and may implement some functions via virtualization. Alternatively, hardware 1830 may be part of a larger cluster of hardware (e.g. such as in a data center or customer premise equipment (CPE)) where many hardware nodes work together and are managed via management and orchestration (MANO) 18100, which, among others, oversees lifecycle management of applications 1820.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a virtual machine 1840 or container is a software implementation of a physical machine that runs programs as if they were executing on a physical, non-virtualized machine. Each of virtual machines 1840 or container, and that part of the hardware 1830 that executes that virtual machine, be it hardware dedicated to that virtual machine and/or hardware shared by that virtual machine with others of the virtual machines 1840 or containers, forms a separate virtual network elements (VNE).

Still in the context of NFV, Virtual Network Function (VNF) is responsible for handling specific network functions that run in one or more virtual machines 1840 or containers on top of hardware networking infrastructure 1830 and corresponds to application 1820 in FIG. 18.

In some embodiments, one or more radio units 18200 that each include one or more transmitters 18220 and one or more receivers 18210 may be coupled to one or more antennas 18225. Radio units 18200 may communicate directly with hardware nodes 1830 via one or more appropriate network interfaces and may be used in combination with the virtual components to provide a virtual node with radio capabilities, such as a radio access node or a base station.

In some embodiments, some signaling can be effected with the use of control system 18230 which may alternatively be used for communication between the hardware nodes 1830 and the radio units 18200.

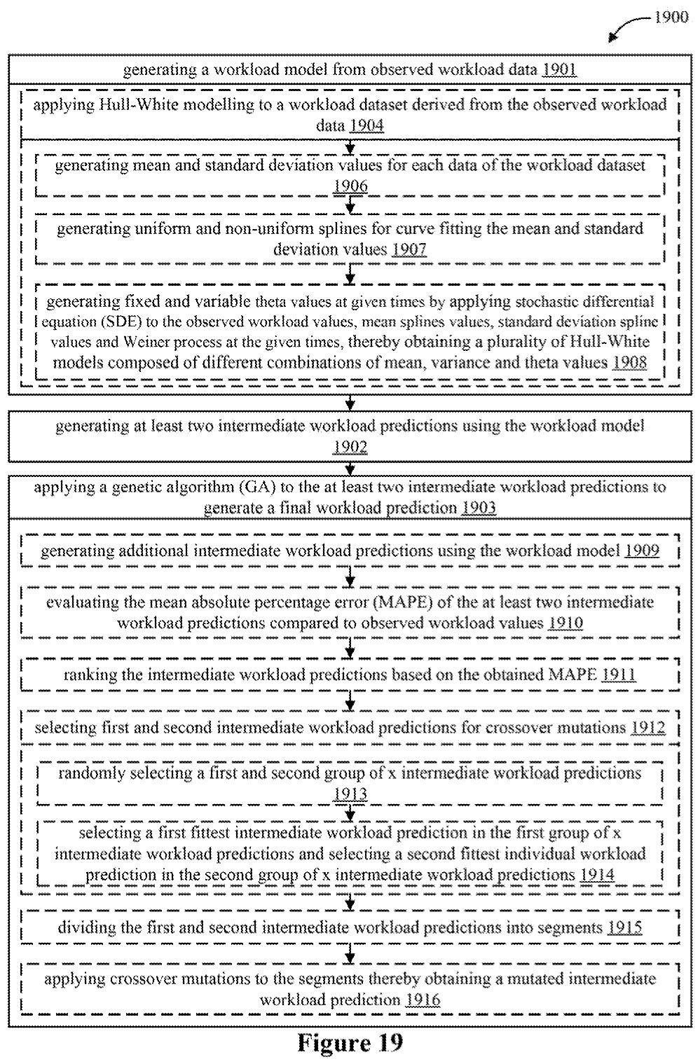

FIG. 19 illustrates a method for estimating workload according to an embodiment which may be executed in standalone network node (which contains the same elements as node 1830, when taken in isolation) or in a cloud environment 1800, such as illustrated in FIG. 18. The method for estimating workload may also be executed in a software instance, application instance, virtual appliance, network function, virtual node or as a virtual network function 1820. The method for estimating, step 1901, workload comprises generating a workload model from observed workload data; generating, step 1902, at least two intermediate workload predictions using the workload model; and applying, step 1903, a genetic algorithm (GA) to the at least two intermediate workload predictions to generate a final workload prediction.

Generating the workload model may comprise applying, step 1904, Hull-White modelling to a workload dataset derived from the observed workload data.

The workload dataset may comprise workload attributes such as CPU, RAM usage, traffic load, disk I/O, throughput or other similar attributes, as would be apparent to a person skilled in the art. Each data of the workload dataset may comprise an observed workload value, a mean value of the observed workload at a given time t, a variance value of the observed workload at time t and a Weiner process.

In the method, applying the Hull-White modelling to the workload data set may comprise generating, step 1906, mean and standard deviation values for each data of the workload dataset; generating, step 1907, uniform and non-uniform splines for curve fitting the mean and standard deviation values; and generating, step 1908, fixed and variable theta values at given times by applying stochastic differential equation (SDE) to the observed workloads, mean splines values, standard deviation spline values and Weiner process at the given times, thereby obtaining a plurality of Hull-White models composed of different combinations of mean, variance and theta values.

The Hull-White modelling may comprise generating a model of uniform splines and fixed theta; a model of uniform splines and variable theta; a model of non-uniform splines and fixed theta; and a model of non-uniform splines with variable theta.

In the method, applying the genetic algorithm (GA) to the workload model may comprise generating, step 1909, additional intermediate workload predictions using the workload model; evaluating, step 1910, the mean absolute percentage error (MAPE) of the at least two intermediate workload predictions compared to observed workload values; ranking, step 1911, the intermediate workload predictions based on the obtained MAPE; selecting, step 1912, first and second intermediate workload predictions for crossover mutations; dividing, step 1915, the first and second intermediate workload predictions into segments; and applying, step 1916, crossover mutations to the segments thereby obtaining a mutated intermediate workload prediction.

In the method selecting the first and second intermediate workload predictions for crossover mutations comprises using a tournament and may comprise: randomly selecting, step 1913, a first and second group of x intermediate workload predictions; and selecting, step 1914, a first fittest intermediate workload prediction in the first group of x intermediate workload predictions and selecting a second fittest intermediate workload prediction in the second group of x intermediate workload predictions.

A method for estimating workload has been previously described in relation with FIGS. 1-17, for example, and the method 1900 may further comprise or alternatively comprise any of the steps described in relation with FIGS. 1-17.

Modifications and other embodiments will come to mind to one skilled in the art having the benefit of the teachings presented in the foregoing description and the associated drawings. Therefore, it is to be understood that modifications and other embodiments, such as specific forms other than those of the embodiments described above, are intended to be included within the scope of this disclosure. The described embodiments are merely illustrative and should not be considered restrictive in any way. The scope sought is given by the appended claims, rather than the preceding description, and all variations and equivalents that fall within the range of the claims are intended to be embraced therein. Although specific terms may be employed herein, they are used in a generic and descriptive sense only and not for purposes of limitation.

1. A method for estimating workload, comprising:
generating a workload model from observed workload data;
generating at least two intermediate workload predictions using the workload model; and
applying a genetic algorithm (GA) to the at least two intermediate workload predictions to generate a final workload prediction.

2. The method of claim 1, wherein generating the workload model comprises applying Hull-White modelling to a workload dataset derived from the observed workload data.

3. The method of claim 2, wherein the workload dataset comprises workload attributes such as CPU, RAM usage, traffic load, disk I/O or throughput.

4. The method of claim 2, wherein each data of the workload dataset comprises an observed workload value, a mean value of the observed workload at a given time t, a variance value of the observed workload at time t and a Weiner process.

5. The method of claim 2, wherein applying the Hull-White modelling to the workload data set comprises:
generating mean and standard deviation values for each data of the workload dataset;
generating uniform and non-uniform splines for curve fitting the mean and standard deviation values; and
generating fixed and variable theta values at given times by applying stochastic differential equation (SDE) to the observed workload values, mean splines values, standard deviation spline values and Weiner process at the given times, thereby obtaining a plurality of Hull-White models composed of different combinations of mean, variance and theta values.

6. The method of claim 2, wherein the Hull-White modelling comprise generating:
a model of uniform splines and fixed theta;
a model of uniform splines and variable theta;
a model of non-uniform splines and fixed theta; and
a model of non-uniform splines with variable theta.

7. The method of embodiment 1, wherein applying the genetic algorithm (GA) to the workload model comprises generating additional intermediate workload predictions using the workload model.

8. The method of claim 1, wherein applying the genetic algorithm (GA) to the workload model comprises:
evaluating the mean absolute percentage error (MAPE) of the at least two intermediate workload predictions compared to observed workload values;
ranking the intermediate workload predictions based on the obtained MAPE;
selecting first and second intermediate workload predictions for crossover mutations;
dividing the first and second intermediate workload predictions into segments; and
applying crossover mutations to the segments thereby obtaining a mutated intermediate workload prediction.

9. The method of claim 8, wherein selecting the first and second intermediate workload predictions for crossover mutations comprises using a tournament comprising:
randomly selecting a first and second group of x intermediate workload predictions; and
selecting a first fittest intermediate workload prediction in the first group of x intermediate workload predictions and selecting a second fittest intermediate workload prediction in the second group of x intermediate workload predictions.

10. An apparatus for estimating workload, comprising processing circuitry and a memory, the memory containing instructions executable by the processing circuitry whereby the apparatus is operative to:
generate a workload model from observed workload data;
generate at least two intermediate workload predictions using the workload model; and
apply a genetic algorithm (GA) to the at least two intermediate workload predictions to generate a final workload prediction.

11. An application instance for estimating workload, in a cloud computing environment which provides processing and interface circuitry and memory for running the application instance, the memory containing instructions executable by the processing circuitry whereby the application instance is operative to:
generate a workload model from observed workload data;
generate at least two intermediate workload predictions using the workload model; and
apply a genetic algorithm (GA) to the at least two intermediate workload predictions to generate a final workload prediction.

12. The apparatus of claim 10, further operative to apply Hull-White modelling to a workload dataset derived from the observed workload data.

13. The apparatus of claim 12, wherein the workload dataset comprises workload attributes such as CPU, RAM usage, traffic load, disk I/O or throughput.

14. The apparatus of claim 12, wherein each data of the workload dataset comprises an observed workload value, a mean value of the observed workload at a given time t, a variance value of the observed workload at time t and a Weiner process.

15. The apparatus of claim 12, further operative to:
generate mean and standard deviation values for each data of the workload dataset;
generate uniform and non-uniform splines for curve fitting the mean and standard deviation values; and
generate fixed and variable theta values at given times by applying stochastic differential equation (SDE) to the observed workload values, mean splines values, standard deviation spline values and Weiner process at the given times, thereby obtaining a plurality of Hull-White models composed of different combinations of mean, variance and theta values.

16. The apparatus of claim 12, wherein the Hull-White modelling comprise generating:
a model of uniform splines and fixed theta;
a model of uniform splines and variable theta;
a model of non-uniform splines and fixed theta; and
a model of non-uniform splines with variable theta.

17. The apparatus of claim 12, further operative to generate additional intermediate workload predictions using the workload model.

18. The apparatus of claim 12, further operative to:
evaluate the mean absolute percentage error (MAPE) of the at least two intermediate workload predictions compared to observed workload values;
rank the intermediate workload predictions based on the obtained MAPE;
select first and second intermediate workload predictions for crossover mutations;
divide the first and second intermediate workload predictions into segments; and
apply crossover mutations to the segments thereby obtaining a mutated intermediate workload prediction.

19. The apparatus of claim 18, further operative to use a tournament and to:
randomly select a first and second group of x intermediate workload predictions; and
select a first fittest intermediate workload prediction in the first group of x intermediate workload predictions and selecting a second fittest intermediate workload prediction in the second group of x intermediate workload predictions.
